(19) United States
(12) Patent Application Publication
(10) Pub. No.: US 2026/0016933 A1
(43) Pub. Date: Jan. 15, 2026

(54) INTERFACE INTERACTION

(71) Applicants: Lemon Inc., Grand Cayman (KY); Beijing Zitiao Network Technology Co., Ltd., Beijing (CN)

(72) Inventors: Mingyi Lu, CULVER, CA (US); Tianhao He, CULVER, CA (US); Chenman Zhou, Beijing (CN); Linyi Zheng, Beijing (CN); Ye Lin, Beijing (CN)

(21) Appl. No.: 19/264,766

(22) Filed: Jul. 9, 2025

Related U.S. Application Data
(63) Continuation of application No. PCT/CN2024/104562, filed on Jul. 9, 2024.

(51) Int. Cl. G06F 3/0483; G06F 3/0484; G06F 3/0488; G06F 9/451

(52) U.S. Cl. CPC G06F 3/0483; G06F 3/0484; G06F 3/0488; G06F 9/453

(57) ABSTRACT

Embodiments of the disclosure relate to interface interaction. The method provided herein includes: displaying a first present page of a first media content in a media stream based on media stream downloaded from a server; displaying a first information display page based on a first sliding instruction received in the first present page, the first information display page displaying a first group of media contents associated with the first media content; and in response to receiving a second sliding instruction in the first information display page, displaying a second present page of a second media content in the media stream, a direction associated with the second sliding instruction being different from a direction associated with the first sliding instruction. In this manner, the embodiments of the present disclosure can improve the efficiency of recommending media contents.

### CROSS REFERENCE TO RELATED APPLICATION

This application claims priority to International Application No. PCT/CN2024/104562, filed on Jul. 9, 2024, entitled “method, apparatus, device and storage medium for interface interaction”, the entirety of which is incorporated herein by reference.

### FIELD

Example embodiments of the present disclosure generally relate to the field of computers, and more particularly, to interface interaction.

### BACKGROUND

In recent years, with the development of the Internet, more and more people view content of media contents on a network platform. For example, people use a media platform to view various media contents. However, when a user views a media content on a traditional media platform and performs an interaction operation based on a traditional method, recommended content cannot be presented to the user conveniently and efficiently.

### SUMMARY

In a first aspect of the present disclosure, a method for interface interaction is provided, including: displaying a first present page of a first media content in a media stream based on media stream downloaded from a server; displaying a first information display page based on a first sliding instruction received in the first present page, the first information display page displaying a first group of media contents associated with the first media content; and in response to receiving a second sliding instruction in the first information display page, displaying a second present page of a second media content in the media stream, a direction associated with the second sliding instruction being different from a direction associated with the first sliding instruction.

In a second aspect of the present disclosure, an apparatus for interface interaction is provided. The apparatus includes: a first presentation module configured to display a first present page of a first media content in a media stream based on media stream downloaded from a server; a second presentation module configured to display a first information display page based on a first sliding instruction received in the first present page, the first information display page displaying a first group of media contents associated with the first media content; and a third presentation module configured to display, in response to receiving a second sliding instruction in the first information display page, a second present page of a second media content in the media stream, wherein a direction associated with the second sliding instruction is different from a direction associated with the first sliding instruction.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer readable storage medium is provided. The computer readable storage medium stores a computer program thereon, and the computer program is executable by a processor to implement the method in the first aspect.

It should be appreciated that what is described in this Summary is not intended to limit critical features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar drawing reference signs denote the same or similar elements, wherein:

FIG. 1 illustrates a schematic diagram of an example environment in which embodiments according to the present disclosure may be implemented in real time;

FIGS. 2A-2I illustrate example interfaces according to some embodiments of the present disclosure;

FIG. 3 illustrates a flowchart of an example process for interface interaction according to some embodiments of the present disclosure;

FIG. 4 illustrates a schematic structural block diagram of an example apparatus for interface interaction according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms and should not be construed as limited to the embodiments set forth herein, but rather, these embodiments are provided for a thorough and complete understanding of this present disclosure. It should be understood that the drawings and embodiments of the present disclosure are for illustrative purposes only and are not intended to limit the scope of the present disclosure.

It is important to note that heading of any section/subsection provided in this article is not limiting. Various embodiments are described throughout herein, and any type of embodiments can be included under any section/subsection. Furthermore, the embodiments described in any section/subsection may be combined in any way with any other embodiments described in the same section/subsection and/or in a different section/subsection.

In the description of embodiments of the present disclosure, the term “including” and similar expressions shall be understood as an open-ended inclusion, that is, “including but not limited to”. The term “based on” should be understood to mean “based at least in part on.” The term “an embodiment” or “the embodiment” shall be understood to mean “at least one embodiment”. The term “some embodiments” should be understood as “at least some embodiments”. Other explicit and implicit definitions may be included below. The terms “first”, “second”, etc. may refer to different or the same object. Other explicit and implicit definitions may be included below.

Embodiments of the present disclosure may involve user data, the obtaining and/or use of data, etc. These aspects comply with corresponding laws, regulations and relevant regulations. In the embodiments of this disclosure, collection, obtaining, processing, processing, forwarding, use, etc. of all data are performed with the user's knowledge and confirmation. Accordingly, when implementing each embodiment of the present disclosure, users should be informed of the type, scope of use, usage scenarios, etc. that may be involved in the data or information and obtain their authorization through appropriate means in accordance with relevant laws and regulations. The specific notification and/or authorization methods may vary according to the actual situation and application scenarios, and the scope of the present disclosure is not limited in this regard.

In the technical solution in this description and embodiments, if the processing of personal information is involved, the processing will be carried out on the premise that there is a basis of legality (e.g., consent of the subject of the personal information is obtained or it is necessary to fulfill a contract, etc.), and the processing will be carried out only within the scope of the stipulations or agreements. The user refusing to process personal information other than that which is necessary for the basic functions will not affect the user's use of the basic functions.

As mentioned briefly above, with the development of the Internet, more and more people view media contents on a network platform. For example, people view various media contents by using a media platform.

However, when a user views a media content on a traditional media platform and performs an interaction operation based on a traditional method, recommended content cannot be presented to the user conveniently and efficiently based on the interaction operation.

Embodiments of the present disclosure provide a solution for interface interaction. According to the solution, a first present page of a first media content in a media stream may be displayed based on media stream downloaded from a server; a first information display page is displayed based on a first sliding instruction received in the first present page, the first information display page displaying a first group of media contents associated with a first media content; and in response to receiving a second sliding instruction in the first information display page, a second present page of the second media content in the media stream is displayed, a direction associated with the second sliding instruction is different from a direction associated with the first sliding instruction.

In this way, in the embodiments of the present disclosure, when a sliding instruction performed by a user on a first media content is received, a recommended media content display page associated with the first media content can be switched to, and after a further sliding instruction performed by the user is received, a present page of a second media content can be presented. In this way, embodiments of the present disclosure can provide recommended content for a user based on a sliding instruction of the user, thereby improving interaction efficiency and showing efficiency of the recommended content.

Furthermore, based on this manner, the embodiments of the present disclosure can provide more styles in a limited screen area of a mobile terminal to present media content, thereby enriching the presentation types of media content and the number of pieces of media content. In addition, by providing related media contents for a user in a page interaction process, the embodiments of the present disclosure further improve the efficiency of information acquisition.

Various example implementations of the solution are described in further detail below with reference to the accompanying drawings.

### Example Environment

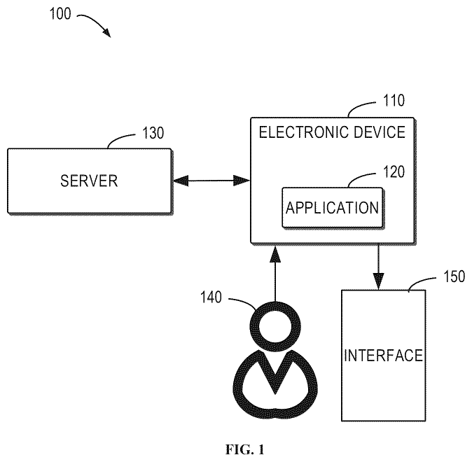

FIG. 1 illustrates a schematic diagram of an example environment 100 in which embodiments of the present disclosure can be implemented. As shown in FIG. 1, example environment 100 may include an electronic device 110.

In this example environment 100, an application 120 that supports interface interaction may run on an electronic device 110. The application 120 may be any suitable type of application for interface interaction, examples of which may include but are not limited to: a video application, a social application, or other appropriate applications. A user 140 may interact with application 120 via the electronic device 110 and/or its attached devices.

In the environment 100 of FIG. 1, if the application 120 is in an active state, the electronic device 110 may present an interface 150 for supporting interface interaction through the application 120.

In some embodiments, the electronic device 110 communicates with the server 130 to enable provision of services to the application 120. The electronic device 110 may be any type of a mobile terminal, a fixed terminal or a portable terminal, including a mobile phone, a desktop computer, a laptop computer, a notebook computer, a netbook computer, a tablet computer, a media computer, a multimedia tablet, a palmtop computer, a portable game terminal, a VR/AR equipment, a Personal Communication System (PCS) device, a personal navigation device, a Personal Digital Assistant (PDA), an audio/video player, a digital cameras/camcorder, a positioning device, a TV receiver, a radio receiver, an e-book device, a gaming device, or any combination of the foregoing, including accessories and peripherals for these devices or any combination thereof. In some embodiments, the electronic device 110 can also support any type of interface targeted to the user (such as “wearable” circuitry, etc.).

The server 130 may be an independent physical server, or a server cluster or distributed system consisted of a plurality of physical servers, or a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server such as a mainframe, an edge computing node, a computing device in a cloud environment, or the like. The server 130 may provide background services for the applications 120 in the electronic device 110 that support virtual scenarios.

A communication connection may be established between the server 130 and the electronic device 110. Communication connections can be established via wired or wireless manner. Communication connections may include but are not limited to Bluetooth connections, mobile network connections, Universal Serial Bus (USB) connections, Wireless Fidelity (WIFI) connections, etc. The embodiments of the present disclosure are not limited in this regard. In the embodiments of the present disclosure, the server 130 and the electronic device 110 can implement signaling interaction through the communication connection therebetween.

It should be understood that the structure and function of various elements in environment 100 are described for illustrative purposes only and do not imply any limitation on the scope of the present disclosure.

Some example embodiments of the present disclosure will continue to be described below with reference to the accompanying drawings.

### Example Interactions

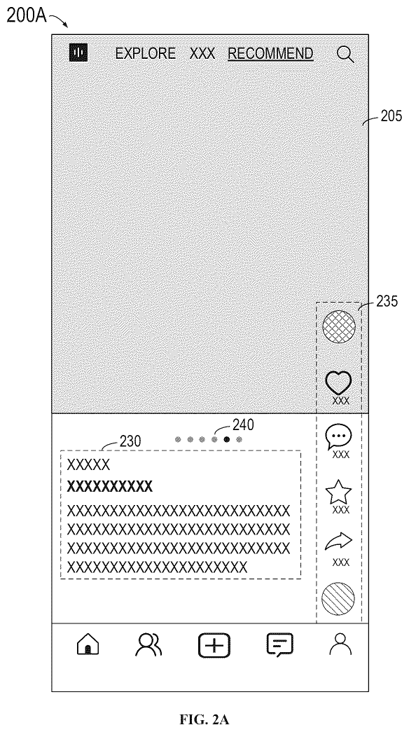

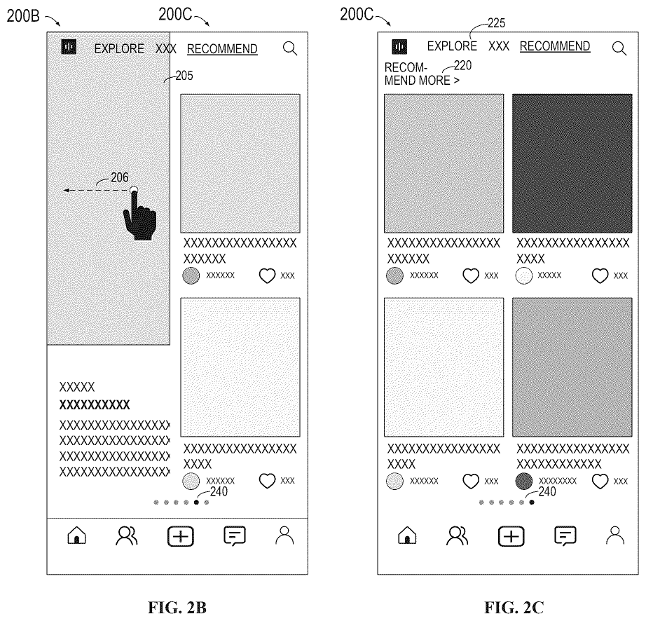

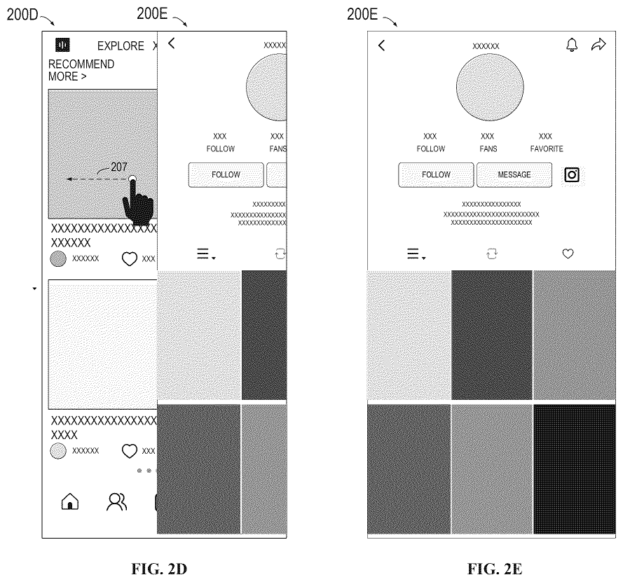

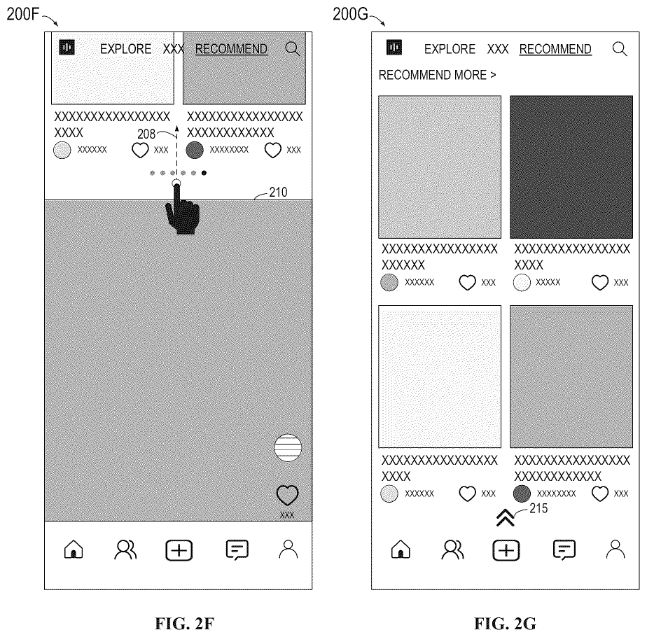

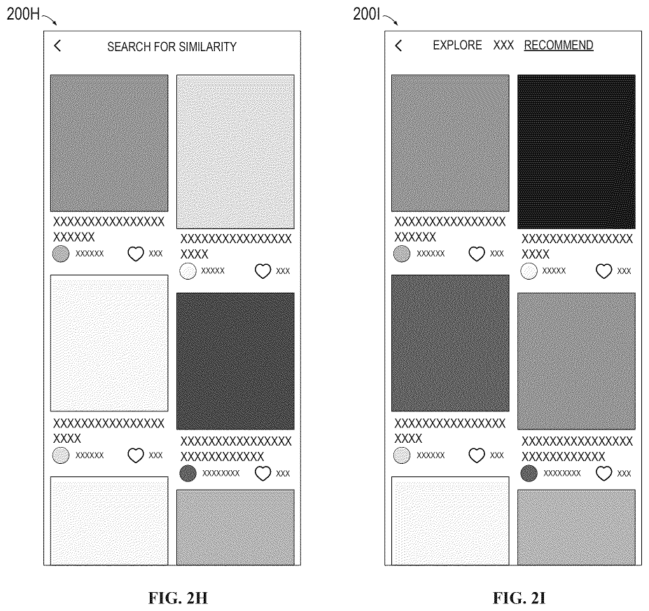

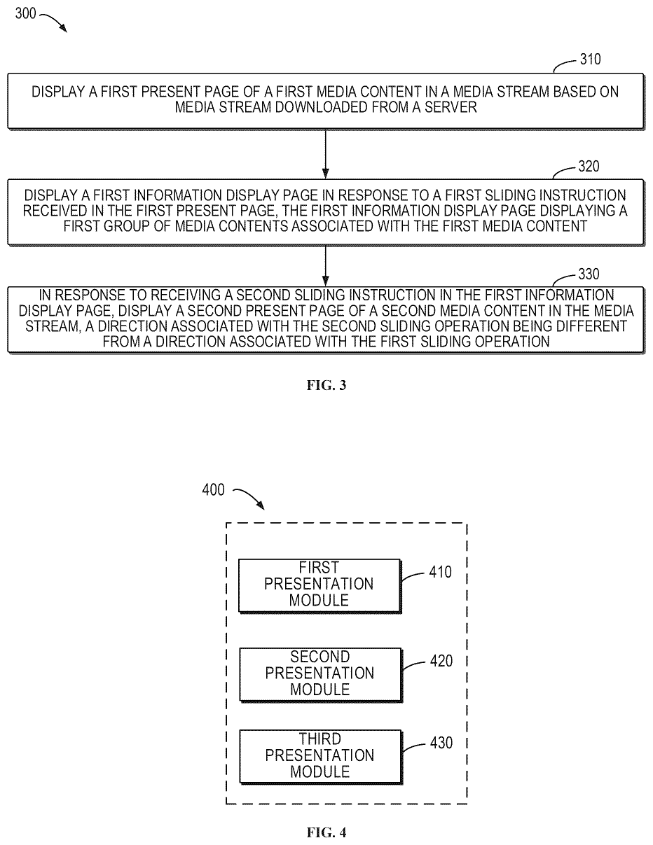

FIGS. 2A-2I illustrate example interfaces 200A-200I according to some embodiments of the disclosure. The interfaces 200A-200I may, for example, be provided by the electronic device 110 shown in FIG. 1.

In some embodiments, as shown in FIG. 2A, the electronic device 110 may display a first present page 200A of a first media content 205 in the media stream based on media stream downloaded from a server. The electronic device 110 may display the image content of the first media content 205 (I. e., playing the media content) in the first present page 200A. As an example, the media stream may correspond to a plurality of media contents including the first media content. As an example, the types of media contents may include a video type, a graphic and textual type, etc. As an example, a media content may include, for example, a video or a plurality of images.

In some embodiments, with continued reference to FIG. 2A, in response to image content of the first media content 205 currently displayed in the first present page satisfying a predetermined condition, the electronic device 110 may display the first information display page 200C based on the first sliding instruction.

In some embodiments, with continued reference to FIG. 2A, the first media content 205 may include a plurality of images, and the predetermined condition includes the currently displayed image content being a last image of the plurality of images. As an example, the predetermined condition satisfied by the currently displayed image content is that the currently displayed image content is content of the last image in the first media content 205.

In some embodiments, with continued reference to FIG. 2A, the electronic device 110 may switch to different images in the first media content 205 based on the fourth sliding instruction. A direction associated with the fourth sliding instruction is parallel to a direction associated with the first sliding instruction. As an example, the electronic device 110 may move the currently displayed image content based on the received fourth sliding instruction, and present either content of the previous image or content of the next image in first media content 205.

In some embodiments, with continued reference to FIG. 2A, the electronic device 110 may also display progress indication elements 240 in the first present page 200A. The progress indication elements 240 may be used to indicate a position of the image content currently displayed on the first present page in the first media content 205. As an example, as shown in FIG. 2A, the progress indication elements 240 may include six elements (small circles), for example, the progress indication elements may characterize at least five pieces of image content included in first media content 205. As an example, the electronic device 100 displays the second-to-last element (second-to-right) in the progress indication element 240 differently, which may characterize the image content currently displayed as the last piece of image content in the first media content 205. As an example, the last element (rightmost element) of the progress indication element 240 is configured to indicate the first information display page.

In some embodiments, as shown in FIG. 2B, the electronic device 110 moves the first present page 200B based on the first sliding instruction received in the first present page 200B and displays the first information display page 200C. As an example, the direction indicated by the first arrow 206 in FIG. 2B may indicate a moving direction associated with the first present page 200B.

In some embodiments, with continued reference to FIG. 2B, the first media content 205 can be video content and the electronic device 110 may pause or continue playing the video content based on the received first sliding instruction while moving the first present page 200B.

In some embodiments, with continued reference to FIG. 2B, the electronic device 110 may pause playing background music or adjust the background music to a silent state based on the received first sliding instruction while moving the first present page 200B.

In some embodiments, with continued reference to FIG. 2A, the electronic device 110 may present at least one interface element in the first present page 200A.

In some embodiments, with continued reference to FIG. 2A, the at least one interface element may include a first interface element 230 associated with text content of the first media content. As an example, as shown in FIG. 2A, the first interface element 230 associated with the text content of the media content may include, for example, name of the media content, a brief description of the media content, an author name, etc.

In some embodiments, with continued reference to FIG. 2A, the at least one interface element may include a second interface element 235 for interacting with the first media content. By way of example, the second interface element 235 may include, for example, a group of interactive controls associated with a media content. As an example, a group of interactive controls may include, for example, a like control, a comment control, a collect control, and/or a forward control, among others.

In some embodiments, with continued reference to FIG. 2B, the electronic device 110 can adjust the visibility of at least one interface element in the first present page 200B based on a received interaction operation without changing the position of the at least one interface element. By way of example, the electronic device 110 can adjust the transparency (e.g., decreasing the transparency) of first interface element 230 based on the received first sliding instruction. By way of example, the electronic device 110 may stop presenting the second interface element 235 in the first present page 200B based on the received first sliding instruction (e. g., it may be understood as adjusting the second interface element 235 to be invisible).

In some embodiments, as shown in FIG. 2C, the electronic device 110 may present the first information display page 200C in response to the end state of the first sliding instruction satisfying a first trigger condition. As an example, as shown in FIG. 2B, the end state of the first sliding instruction satisfying the first trigger condition may include that, at the end of the sliding instruction, a sliding distance of the sliding instruction in a sliding direction (for example, a direction indicated by a first arrow 206) satisfies a first threshold. As an example, the first threshold may be determined by a related art, and the present disclosure is not intended to limit the specific value of the first threshold.

In some embodiments, with continued reference to FIG. 2C, the electronic device 110 may update the progress indication elements 240 in response to the first information display page 200C being displayed (i. e., displayed entirely). As an example, as shown in FIG. 2B, the electronic device 110 displays the last element (the rightmost element) in the progress indication elements 240 differently to characterize what is the currently displayed is the first information display page 200C.

In some embodiments, with continued reference to FIG. 2C, the first information display page displays a first group of media contents associated with the first media content 205. As an example, the first group of media contents may include a plurality of media contents associated with the first media content 205.

In some embodiments, with continued reference to FIG. 2C, the electronic device 110 may present, in the first information display page 200C, the first group of media contents associated with the first media content 205 in a first layout style. In some embodiments, the first layout style is a multi-row layout style or a multi-column layout style.

In some embodiments, with continued reference to FIG. 2C, the electronic device 110 may display, in response to receiving a selection of the third media content from the first group of media contents, a third present page of the third media content (reference can be made to the first present page in FIG. 2A, and the difference merely lies in that the third present page presents the third media content different from the first media content 205).

In some embodiments, with continued reference to FIG. 2C, the electronic device 110 can switch to display the first present page 200A in response to receiving in the first information display page 200C a sliding instruction opposite to the sliding direction associated with the first sliding instruction (e. g., the direction indicated by the first arrow 206 in FIG. 2B).

In some embodiments, as shown in FIG. 2D, the electronic device 110 may display a second information display page 200E associated with the first media content 205 in response to receiving the third sliding instruction in the first information display page 200C. A direction associated with the third sliding instruction is the same as that of the first sliding instruction. For example, a sliding direction associated with the third sliding instruction may be a direction indicated by the second arrow 207 in FIG. 2D.

In some embodiments, as shown in FIG. 2E, the electronic device 110 may present, in response to an end state of the third sliding instruction satisfying a second trigger condition, a second information display page 200E associated with the first media content 205. As an example, as shown in FIG. 2D, the end state of the third sliding instruction satisfying the second trigger condition may include that, when the sliding instruction ends, a sliding distance of the sliding instruction in the sliding direction (for example, a direction indicated by a second arrow 207 in FIG. 2D) satisfies a second threshold. As an example, the second threshold may be determined by a related art, and the present disclosure is not intended to limit the specific value of the first threshold.

In some embodiments, the second information display page 200E may include a details page of the first media content, or a personal page of a user associated with the first media content.

In some embodiments, the details page of the first media content may include entire text content, the tag content, and/or media content review content of the first media content. As an example, the entire text content of the first media content may include a title of the first media content, an author name, a media content introduction, etc. By way of example, the comment content of the first media content may include, among other things, comment content and commenting time associated with the media content published by other users (different from the author of the media content).

In some embodiments, with continued reference to FIG. 2E, the personal page of the user associated with the first media content may include personal introduction information of the user associated with the first media content, a plurality of media contents and other related information, etc.

In some embodiments, as shown in FIG. 2F, the electronic device 110 may display a second present page associated with second media content 210 in response to receiving the second sliding instruction in the first information display page. In some embodiments, a sliding direction associated with the second sliding instruction is different from a sliding direction associated with the first sliding instruction. As an example, the sliding direction associated with the second sliding instruction may be, for example, a direction as indicated by a third arrow 208 in FIG. 2F.

In some embodiments, with continued reference to FIG. 2F, the electronic device 110 may display a transition animation from the first information display page to the second display page in response to receiving the second sliding instruction in the first information display page. The transition animation may include increasing a first display ratio of the second present page and decreasing a second display ratio of the first information display page based on the second sliding instruction. Further, the electronic device 110 may present a second present page associated with second media content 210 in response to the end of the transition animation.

In some embodiments, with continued reference to FIG. 2F, the second present page may be a present page corresponding to the second media content 210 in the media stream. As an example, the electronic device 110 may present the second media content 210 in the second present page. As an example, the layout style of the second present page may be the same as the layout style of the first present page.

In some embodiments, as shown in FIG. 2G, in the first information display page 200G, the electronic device 110 may display an interaction guidance element 215 in the first information display page 200G in response to an instruction (or operation) for the first information display page 200G not being received within a preset time period. The interaction guidance element 215 is associated with an interaction operation (or interaction instruction) of a target type that is supported by the first information display page 200C. As an example, the interaction guidance element 215 may guide the user to perform the interaction operation supported by the first information display page 200C. As an example, the target type may correspond to different sliding directions, or an interaction entry that supports interactive operations.

In some embodiments, with continued reference to FIG. 2G, the interaction guidance element 215 may guide the user to perform a sliding instruction in a direction indicated by the interaction indication element 215, so as to switch to a second present page corresponding to the second media content 210 in the media stream.

In some embodiments, with continued reference to FIG. 2C, the electronic device 110 can display the third information display page in response to triggering the access entry in the first information display page 200C. The third information display page may display a second group of media contents associated with the first media content.

In some embodiments, with continued reference to FIG. 2C, the electronic device 110 can provide the first entry 220 in the first information display page 200C.

In some embodiments, as shown in FIG. 2H, the electronic device 110 can display the third information display page 200H in response to receiving a trigger to the first entry 220 in the first information display page 200C. As an example, the electronic device 110 may display a second group of media contents associated with the first media content 205 in the third information display page 200H. As an example, the second group of media contents may include a plurality of second recommended media contents.

In some embodiments, with continued reference to FIG. 2H, the second layout style of the second group of media contents in the third information display page 200H is the same as the first layout style of the first group of media contents in the first information display page 200C. As an example, the second layout style may be a multi-row layout style or a multi-column layout style.

In some embodiments, with continued reference to FIG. 2H, the first group of media contents may be a subset of the second group of media contents. As an example, the second group of media contents may include all or a portion of the first group of media contents.

In some embodiments, with continued reference to FIG. 2C, the electronic device 110 may provide a second entry 225 in the first information display page 200C.

In some embodiments, as shown in FIG. 2I, the electronic device 110 can display the third information display page 200I in response to receiving a trigger to the second entry 225 in the first information display page 200C. As an example, the electronic device 110 may display a third group of media contents associated with the first media content 205 in the third information display page 2001. As an example, the third group of media contents may include a plurality of third recommended media contents. In some embodiments, as shown in FIG. 2I, the third layout style of the third group of media contents in the third information display page 2001 is the same as the first layout style of the first group of media contents in the first information display page 200C. As an example, the third layout style may be a multi-row layout style or a multi-column layout style.

Based on the process described above, after receiving the first sliding instruction from the user, the embodiment of the present disclosure can present, based on the first sliding instruction, the first information display page associated with media contents and including a plurality of recommended media contents. Further, the embodiments of the present disclosure may present a present page of the second media content or a second information display page associated with the first media content based on the second sliding instruction received in the first information display page.

Furthermore, the embodiments of the present disclosure can provide more styles in a limited screen area of a mobile terminal to present media content, thereby enriching the presentation types of media contents and the number of pieces of media contents content. In addition, by providing related media contents for a user in a page interaction process, the embodiments of the present disclosure further improve the efficiency of information acquisition.

In this way, the present disclosure can conveniently show the recommended content based on the user's operation or instruction, and can guide the user to switch to a corresponding interface. In addition, the present disclosure can improve showing efficiency of a details page of a media content or a personal page of a user and an interaction experience of the user.

### Example Process

FIG. 3 illustrates a flowchart of an example process 400 for interface interaction according to some embodiments of the disclosure. The process 300 may be implemented at the electronic device 110. The process 300 is described below with reference to FIG. 1.

As shown in FIG. 3, at block 310, the electronic device 110 displays a first present page of a first media content in a media stream based on media stream downloaded from a server.

At block 320, the electronic device 110 displays a first information display page based on a first sliding instruction received in the first present page, the first information display page displaying a first group of media contents associated with the first media content.

At block 330, in response to receiving a second sliding instruction in the first information display page, the electronic device 110 displays a second present page of a second media content in the media stream, a direction associated with the second sliding instruction is different from a direction associated with the first sliding instruction.

In some embodiments, the process 300 further includes, in response to receiving a third sliding instruction in the first information display page, displaying a second information display page associated with the first media content, a direction associated with the third sliding instruction is the same as the direction associated with the first sliding instruction.

In some embodiments, the second information display page includes a details page of the first media content, or a personal page of a user associated with the first media content.

In some embodiments, the process 300 further includes, in response to triggering an access entry in the first information display page, displaying a third information display page, the third information display page displaying a second group of media contents associated with the first media content.

In some embodiments, a first layout style of the second group of media contents in the third information display page is the same as a second layout style of the first group of media contents in the first information display page.

In some embodiments, the first layout style and the second layout style are a multi-row layout style or a multi-column layout style.

In some embodiments, the first group of media contents is a subset of the second group of media contents.

In some embodiments, the process 300 further includes, in response to an instruction for the first information display page not being received within a preset time period, displaying an interaction guidance element in the first information display page, the interaction guidance element being associated with an interaction operation of a target type supported by the first information display page.

In some embodiments, displaying the first information display page includes: in response to image content of the first media content currently displayed in the first present page satisfying a predetermined condition, displaying the first information display page based on the first sliding instruction.

In some embodiments, the first media content includes a plurality of images, and the predetermined condition comprises the image content currently displayed being a last image in the plurality of images.

In some embodiments, a direction associated with the first sliding instruction is parallel to a direction associated with a fourth sliding instruction, and the fourth sliding instruction is configured to switch to display different images of the first media content.

In some embodiments, the first present page displays a progress indication element, the progress indication element being configured for indicating a position of image content currently displayed on the first present page in the first media content; and the method further includes: in response to the first information display page being displayed, updating the progress indication element.

In some embodiments, the process 300 further includes, in response to the first information display page being displayed, updating the progress indication element.

In some embodiments, in response to receiving the second sliding instruction in the first information display page, displaying the second present page of the second media content in the media stream includes displaying a transition animation from the first information display page to the second present page, the transition animation comprises increasing a first display ratio of the second present page and decreasing a second display ratio of the first information display page based on the second sliding instruction.

### Example Apparatus and Device

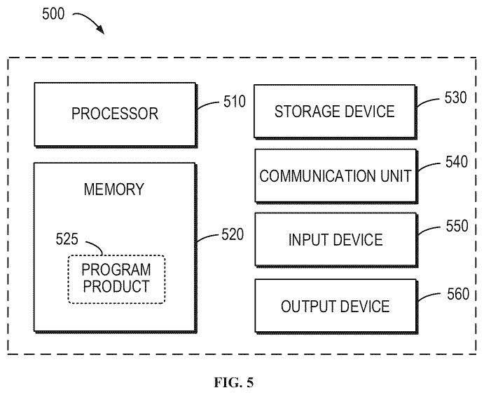

Embodiments of the present disclosure also provide a corresponding apparatus for implementing the above methods or processes. FIG. 4 illustrates a schematic structural block diagram of an example apparatus 400 for interface interaction in accordance with certain embodiments of the present disclosure. The apparatus 400 may be implemented as or included in an electronic device. The various modules/components in the apparatus 400 may be implemented by hardware, software, firmware, or any combination thereof.

As shown in FIG. 4, the apparatus 400 includes a first presentation module 410 configured to display a first present page of a first media content in a media stream based on media stream downloaded from a server; a second presentation module 420 configured to display a first information display page based on a first sliding instruction received in the first present page, the first information display page displaying a first group of media contents associated with the first media content; and a third presentation module 430 configured to display, in response to receiving a second sliding instruction in the first information display page, a second present page of a second media content in the media stream, wherein a direction associated with the second sliding instruction is different from a direction associated with the first sliding instruction.

In some embodiments, the apparatus 400 further includes a fourth presentation module configured to display, in response to receiving a third sliding instruction in the first information display page, a second information display page associated with the first media content, a direction associated with the third sliding instruction is the same as the direction associated with the first sliding instruction.

In some embodiments, the second information display page includes a details page of the first media content, or a personal page of a user associated with the first media content.

In some embodiments, the apparatus 400 further includes an accessing module configured to display, in response to triggering an access entry in the first information display page, a third information display page, the third information display page displaying a second group of media contents associated with the first media content.

In some embodiments, a first layout style of the second group of media contents in the third information display page is the same as the second layout style of the first group of media contents in the first information display page.

In some embodiments, the first layout style and the second layout style are a multi-row layout style or a multi-column layout style.

In some embodiments, the first group of media contents is a subset of the second group of media contents.

In some embodiments, the apparatus 400 further includes an interacting module, and the interacting module is configured to: in response to an instruction for the first information display page not being received within a preset time period, display an interaction guidance element in the first information display page, the interaction guidance element being associated with an interaction operation of a target type supported by the first information display page.

In some embodiments, the first presentation module 410 is further configured to display, in response to image content of the first media content currently displayed in the first present page satisfying a predetermined condition, the first information display page based on the first sliding instruction.

In some embodiments, the first media content includes a plurality of images, and the predetermined condition includes the image content currently displayed being a last image in the plurality of images.

In some embodiments, a direction associated with the first sliding instruction is parallel to that of a fourth sliding instruction, and the fourth sliding instruction is configured to switch to display different images of the first media content.

In some embodiments, the first present page displays a progress indication element, the progress indication element being configured for indicating a position of image content currently displayed on the first present page in the first media content; the apparatus 400 further comprises an updating module, and the updating module is configured to update the progress indication element in response to the first information display page being displayed.

In some embodiments, the apparatus 400 further includes a fifth presentation module configured to display a third present page of the third media content in response to receiving a selection of a third media content from the first group of media contents.

In some embodiments, the third presentation module 430 is further configured to display a transition animation from the first information display page to the second present page, the transition animation including increasing a first display ratio of the second present page and decreasing a second display ratio of the first information display page based on the second sliding instruction.

FIG. 5 illustrates a block diagram of an electronic device 500 in which one or more embodiments of the present disclosure may be implemented. It should be appreciated that the electronic device 500 shown in FIG. 5 is merely exemplary and should not constitute any limitation on the functionality and scope of the embodiments described herein. The electronic device 500 shown in FIG. 5 may be used as the electronic device.

As shown in FIG. 5, the electronic device 500 is in the form of a general-purpose electronic device. Components of the electronic device 500 may include, but are not limited to, one or more processors or processors 510, a memory 520, a storage device 530, one or more communication units 540, one or more input devices 550, and one or more output devices 560. The processor 510 may be an actual or virtual processor and capable of performing various processes according to programs stored in the memory 520. In multiprocessor systems, multiple processors execute computer-executable instructions in parallel to improve the parallel processing capability of electronic device 500.

The electronic device 500 typically includes a plurality of computer storage media. Such media may be any available media accessible by the electronic device 500, including, but not limited to, volatile and non-volatile media, removable and non-removable media. The memory 520 may be a volatile memory (e.g., a register, a cache, a random-access memory (RAM)), a non-volatile memory (e.g., read-only memory (ROM), an electrically erasable programmable read-only memory (EEPROM), flash memory), or some combination thereof. A storage device 530 may be a removable or non-removable medium and may include a machine-readable medium, such as a flash drive, a magnetic disk, or any other medium, which may be used to store information and/or data and may be accessed within the electronic device 500.

The electronic device 500 may further include additional removable/non-removable, volatile/non-volatile storage media. Although not shown in FIG. 5, a disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communications unit 540 implements communications with other electronic devices over a communications medium. Additionally, the functionality of components of the electronic device 500 may be implemented in a single computing cluster or a plurality of computing machines capable of communicating over a communication connection. Thus, the electronic device 500 may operate in a networked environment using logical connections to one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) such as a storage device, a display device, or the like through the communication unit 540 as required, and communicate with one or more devices that enable a user to interact with the electronic device 500, or communicate with any device (e. g., a network card, a modem, or the like) that enables the electronic device 500 to communicate with one or more other electronic devices. Such communication may be performed via an input/output (I/O) interface (not shown).

According to exemplary implementations of the present disclosure, there is provided a computer-readable storage medium having computer instructions stored thereon, where the computer instructions are executed by a processor to implement the method described above. In accordance with exemplary implementations of the present disclosure, there is also provided a computer program product, and the computer program product is tangibly stored on a non-transient computer-readable medium and includes computer-executable instructions, and the computer-executable instructions are executed by the processor to implement the above-described method.

Aspects of the present disclosure are described herein with reference to flowcharts and/or block diagrams of methods, apparatuses, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may also be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some replaced implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for interface interaction, comprising:
displaying a first present page of a first media content in a media stream based on the media stream downloaded from a server;
displaying a first information display page in response to a first sliding instruction received in the first present page, the first information display page displaying a first group of media contents associated with the first media content; and
in response to receiving a second sliding instruction in the first information display page, displaying a second present page of a second media content in the media stream, a direction associated with the second sliding instruction being different from a direction associated with the first sliding instruction.

2. The method of claim 1, further comprising:
in response to receiving a third sliding instruction in the first information display page, displaying a second information display page associated with the first media content, a direction associated with the third sliding instruction being the same as the direction associated with the first sliding instruction.

3. The method of claim 1, wherein the second information display page comprises:
a details page of the first media content, or
a personal page of a user associated with the first media content.

4. The method of claim 1, further comprising:
in response to triggering an access entry in the first information display page, displaying a third information display page, the third information display page displaying a second group of media contents associated with the first media content.

5. The method of claim 4, wherein a first layout style of the second group of media contents in the third information display page is the same as a second layout style of the first group of media contents in the first information display page.

6. The method of claim 5, wherein the first layout style and the second layout style are a multi-row layout style or a multi-column layout style.

7. The method of claim 4, wherein the first group of media contents is a subset of the second group of media contents.

8. The method of claim 1, further comprising:
in response to an instruction for the first information display page not being received within a preset time period, displaying an interaction guidance element in the first information display page, the interaction guidance element being associated with an interaction operation of a target type supported by the first information display page.

9. The method of claim 1, wherein displaying the first information display page comprises:
in response to image content of the first media content currently displayed in the first present page satisfying a predetermined condition, displaying the first information display page based on the first sliding instruction.

10. The method of claim 9, wherein the first media content comprises a plurality of images, and the predetermined condition comprises the image content currently displayed being a last image in the plurality of images.

11. The method of claim 10, wherein a direction associated with the first sliding instruction is parallel to that of a fourth sliding instruction, and the fourth sliding instruction is configured to switch to display different images of the first media content.

12. The method of claim 10, wherein the first present page displays a progress indication element, the progress indication element being configured for indicating a position of image content currently displayed in the first present page in the first media content, and the method further comprises:
in response to the first information display page being displayed, updating the progress indication element.

13. The method of claim 1, further comprising:
in response to receiving a selection of a third media content in the first group of media contents, displaying a third present page of the third media content.

14. The method of claim 1, wherein in response to receiving the second sliding instruction in the first information display page, displaying the second present page of the second media content in the media stream comprises:
displaying a transition animation from the first information display page to the second present page, the transition animation comprising increasing a first display ratio of the second present page and decreasing a second display ratio of the first information display page based on the second sliding instruction.

15. An electronic device, comprising:
at least one processor;
at least one memory coupled to the at least one processor and storing instructions for execution by the at least one processor, the instructions, when executed by the at least one processor, causing the electronic device to perform a method comprising:
displaying a first present page of a first media content in a media stream based on media stream downloaded from a server;
displaying a first information display page in response to a first sliding instruction received in the first present page, the first information display page displaying a first group of media contents associated with the first media content; and
in response to receiving a second sliding instruction in the first information display page, displaying a second present page of a second media content in the media stream, a direction associated with the second sliding instruction being different from a direction associated with the first sliding instruction.

16. The device of claim 15, wherein the method further comprises:
in response to receiving a third sliding instruction in the first information display page, displaying a second information display page associated with the first media content, a direction associated with the third sliding instruction being the same as the direction associated with the first sliding instruction.

17. The device of claim 15, wherein the second information display page comprises:
a details page of the first media content, or
a personal page of a user associated with the first media content.

18. The device of claim 15, wherein the method further comprises:
in response to triggering an access entry in the first information display page, displaying a third information display page, the third information display page displaying a second group of media contents associated with the first media content.

19. The device of claim 15, wherein displaying the first information display page comprises:
in response to image content of the first media content currently displayed in the first present page satisfying a predetermined condition, displaying the first information display page based on the first sliding instruction.

20. A non-transitory computer readable storage medium, having a computer program stored thereon, the computer program being executable by a processor to implement a method comprising:
displaying a first present page of a first media content in a media stream based on media stream downloaded from a server;
displaying a first information display page in response to a first sliding instruction received in the first present page, the first information display page displaying a first group of media contents associated with the first media content; and
in response to receiving a second sliding instruction in the first information display page, displaying a second present page of a second media content in the media stream, a direction associated with the second sliding instruction being different from a direction associated with the first sliding instruction.
